(19) United States
(12) Patent Application Publication
(10) Pub. No.: US 2008/0013792 A1
(43) Pub. Date: Jan. 17, 2008

(54) Workstation With A Variable-Scale Display

(75) Inventors: Jean-Roch Houllier, Saint-Michel sur Orge (FR); Alain Brethereau, Viroflay (FR); Beatrix De Mathan, Paris (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/813,193

(22) PCT Filed: Dec. 22, 2005
(86) PCT No.: PCT/FR05/51126

§ 371 Date: Jul. 21, 2007

(30) Foreign Application Priority Data
Dec. 31, 2004 (FR) 0453274

(51) Int. Cl. G06K 9/00; G06F 3/01; G09G 5/00

(52) U.S. Cl. 382/113; 345/156; 715/765

(57) ABSTRACT

The workstation (10) comprises: a unit (14) for displaying at least one map comprising a background and a set of symbols distributed over the background; an interface (16, 18, 19, 19A) for enabling the user to select the appearance of the map; and control means (20) for controlling the display unit (14) to modify the appearance of the map as a function of an appearance selection made by the user by means of the selection interface (16, 18, 19, 19A). The interface includes means (19) for selecting the size only of at least one symbol. The control means (20) are adapted to cause the display unit (14) to modify the size of the or each symbol as a function of the size selected, without modifying the scale of the background of the map.

The present invention relates to a workstation, of the type comprising a unit for displaying at least one map comprising a background and a set of symbols distributed over the background; an interface for enabling the user to select the appearance of the map; and control means for controlling the display unit to modify the appearance of the map as a function of an appearance selection made by the user by means of the selection interface.

Numerous workstations enabling a map to be displayed include means for changing the scale of the map, whether by enlarging a small zone of the previously-displayed map, or on the contrary by enlarging the viewpoint relative to the initially-displayed fraction of the map. Such means are commonly referred to as providing a “zoom” function.

Said means are particularly convenient, in particular on workstations for optimizing mobile telecommunications networks. The map displayed by the optimization means then presents, for example, the radio broadcasting means installed on a territory, together with the cells associated with the various base stations of the network.

In practice, the map is made up of a background describing the topology of the ground, together with symbols distributed over the background at the exact locations that correspond to the locations of mobile telecommunications elements on the ground.

By way of example, the symbols can be formed by simple geometrical shapes such as crosses, circles, squares, triangles, or by combinations of such simple shapes, or indeed by letters or acronyms contained in an outline that is round, triangular, or square.

When modifying the scale of the map displayed on the workstation, the workstation also causes the size of the symbols displayed and the scale of the map background on which the symbols appear to be modified in corresponding manner.

Thus, if the map is at a small scale, the symbols shown on the background are very small, and under certain circumstances they cannot be distinguished from one another. When the operator seeks to identify the symbols more clearly by enlarging the region of the map containing the symbols, the symbols do indeed become more clearly visible, but the portion of the map displayed by the workstation is very small and restricted to the immediate surroundings of the enlarged symbols. The operator using the workstation, in particular for configuring a mobile telephone network, is then greatly handicapped since only a very small portion of the network is shown.

An object of the invention is thus to propose a solution to the imperfections of the means presently provided on workstations for locally enlarging a map, the solution serving to improve legibility, while nevertheless having a large extent of the map visible.

To this end, the invention provides a workstation of the above-specified type, characterized in that said interface includes means for selecting the size only of at least one symbol; and the control means are adapted to cause the display unit to modify the size of the or each symbol as a function of the selected size without modifying the scale of the map background.

In particular embodiments, the workstation includes one or more of the following characteristics:
the symbols are distributed by type, the interface includes means for selecting size separately for each type of symbol, and the control means are adapted to cause the display unit to modify the size of all of the symbols of a given symbol type as a function of the size selected for that symbol type, without modifying the scale of the map background;
the or each symbol is associated with a set of pixel matrices having the same appearance, and having different dimensions, and the control means are adapted to control the display unit to display one of the pixel matrices as a function of the selected size;
said interface includes means for selecting a region of the map and means for modifying the scale of the background of the selected region of the map, without modifying the size of the symbols distributed over said selected region; and
the selection means are suitable for enabling the size of the or each symbol to be selected in predetermined steps.

The invention can be better understood on reading the following description given purely by way of example and made with reference to the accompanying drawing, in which:

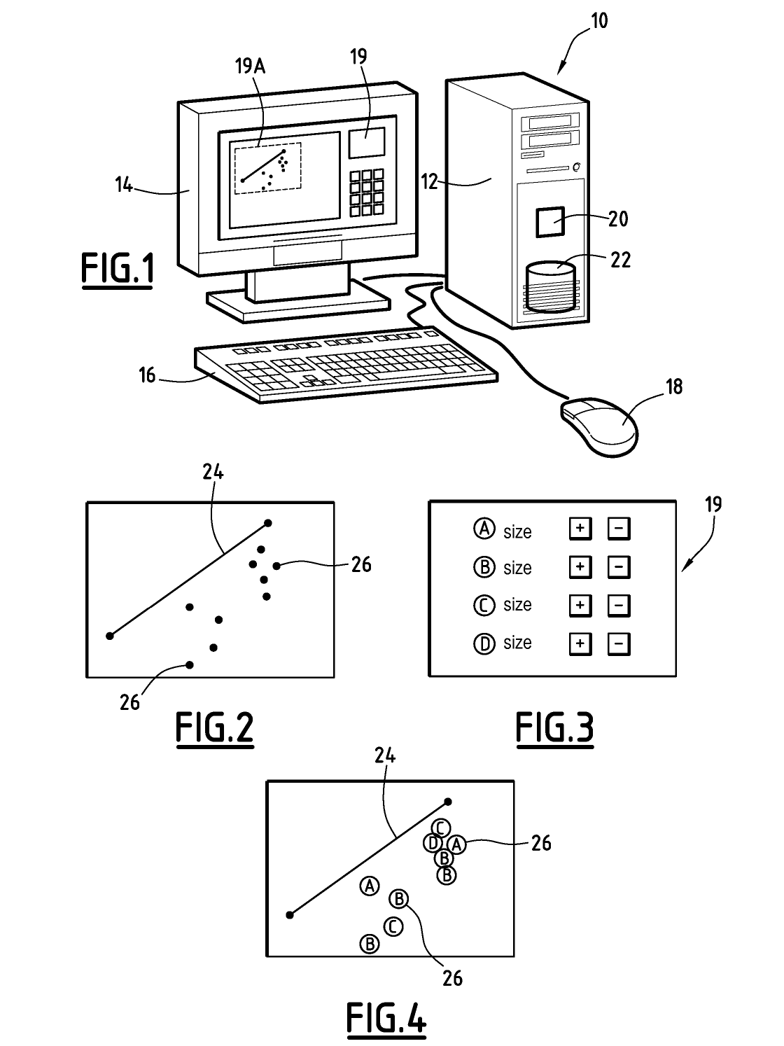

FIG. 1 is a diagrammatic perspective view of an installation of the invention;

FIG. 2 is a diagrammatic view of an enlargement of a zone of the map displayed in FIG. 1, without modifying the size of the symbols;

FIG. 3 is a view on a larger scale of a graphics interface for zoom control in a workstation of the invention; and

FIG. 4 is a view of the enlarged FIG. 2 map in which only the size of the symbols has been enlarged relative to the size of the same symbols in FIG. 2.

The workstation 10 shown in FIG. 1 is for studying and optimizing a mobile telephone network.

In a manner that is itself known, the workstation runs software adapted to display a map representing the mobile telephone network under study.

Thus, the station comprises a central unit 12 for processing information, a display screen 14, and means forming a man/machine interface such as a keyboard 16, and/or a mouse 18 enabling functions to be selected from a graphics interface 19 displayed on the screen 14. The interfaces are suitable in particular for enabling graphics functions to be selected for the purpose of modifying the appearance of the display.

The information processor unit 12 comprises a processor 20 enabling a computer program to be run that processes data and controls the display on the screen 14 on the basis of information received from the keyboard 16 and/or the mouse 18.

In addition, the unit 12 includes data storage means 22, such as a hard disk, serving to store a description of a map and the program run by the workstation.

The program is suitable in particular for displaying on the screen 14 the entire map or a small zone thereof on a larger scale.

To this end, the map comprises, both in its description and in its appearance on the display means 14, a background 24 and a set of symbols 26 distributed over the background.

The background 24 corresponds to the three-dimensional shape of the terrain over the extent of the map, e.g. distinguishing between land, sea, rivers, travel corridors, built-up areas, and certain administrative or technical boundaries.

Each of the symbols 26 distributed over the background corresponds to a network element that is actually present on the ground. The symbols are placed on the background at the locations that correspond to their real locations on the ground.

For example, each symbol is in the form of a geometrical shape and/or a combination of a geometrical shape and an acronym specifying the type of element present on the ground at the location corresponding to the symbol on the background.

Several types of symbol are thus predefined for specifying, for example: base stations of the mobile telephone network, points of connection to a fixed network, exchanges, or any other network object.

For each type of network element, a given symbol is associated with a set of pixel matrices in several sizes. These matrices are stored in the storage means 22. Thus, for example, a symbol of any particular type may be stored in the form of a matrix having dimensions of 4×4, 8×8, 12×12, 16×16, 24×24, 32×32, 48×48, and 64×64 pixels.

The processor 20 of the workstation acting under the control of the program constitutes means for controlling the display unit 14 in order to modify the appearance of the map as a function of a selection made by the user from the selection interface 16, 18, and 19.

Thus, and in known manner, when the entire map is displayed on the screen 14, as shown in FIG. 1, the control means ensure that the network elements are represented by symbols 26 of very small size, e.g. by matrices of 4×4 pixels.

Furthermore, the selection means include the possibility of selecting a determined zone on the map, in order to change the scale of said zone. This change of scale is such that the selected zone occupies on the screen 14 the zone that was previously occupied by the map. Thus, the map displayed is enlarged by the display control means, with the enlargement being performed by a change of scale.

For example, and in known manner, the zone to be enlarged is selected by a box 19A moved over the screen by means of the mouse 18 so as to cover the zone that is to be enlarged.

In a first implementation, and in known manner, the network elements are represented on the enlarged image by symbols of size that is enlarged in the same ratio as the change of scale of the map, as shown in the figure.

Thus, if only one-fourth of the initial map is selected, so that the scale can be doubled, then symbols that were initially 4×4 pixels become represented by symbols of 8×8 pixels.

In a second implementation, and according to the invention, only the background of the map is enlarged and the symbols distributed over the background are maintained at their initial size, as shown in FIG. 2.

Furthermore, the display means make available to the user the graphics interface 19 that enables the user with the keyboard 14 or the mouse 16 to select a new size for each type of symbol individually.

An example of such an interface 19 is shown in FIG. 3. In this figure, each type of network element, shown as a symbol made up of a letter surrounded by a circle, is associated with a “+” button and with a “−” button, enabling the user to move a pointer with the mouse onto one of the buttons and then increase (+button) or on the contrary reduce (−button) the display size of that type of symbol on the screen.

The interface enables size to be selected by type of symbol, thus enabling certain types of symbol that are important to be enlarged while others that are of less use are reduced, with the enlargement, the reduction, and the type of symbol that is to be changed in size being selected by the user.

Thus, acting on one or other of the buttons marked “+” or “−” causes the display unit 14 to modify the size of all of the symbols present on the map that are of the type associated with the button that has been actuated, without changing the scale of the map background, and without moving the symbols in question.

Changes to symbol size takes place in predetermined steps, i.e. the pixel matrix used for displaying a symbol is replaced by the next larger stored matrix when the “+” button is pressed or the next smaller stored matrix when the “−” button is pressed. Thus, for example, if a displayed symbol is formed by a matrix of 8×8 pixels, then it is enlarged by displaying a corresponding matrix of 12×12 pixels, or it is reduced by displaying a matrix of 4×4 pixels.

This variation of size in steps avoids any need for the user to input a numerical value representative of the size.

As shown in FIG. 4, increasing the size of the symbols without any change to scale of the map background enables the user to see more clearly the various symbols, and thus distinguish them from one another, but without losing a portion of the area of the map, and while maintaining correct distances between these various symbols.

It can be understood that with such a workstation, configuring and improving a mobile telephone network becomes simpler, because of the decorrelation between a change in the scale of the map background and a change in the size of the symbols present on the background. Depending on the information needed by the user, it is possible for the user to cause symbols that are of use to appear clearly without that leading to a loss of a portion of the map background, thus enabling the user to continue assessing the distances between the various elements of the network as represented by the symbols.

1. A workstation (10) comprising:
a unit (14) for displaying at least one map comprising a background and a set of symbols distributed over the background;
an interface (16, 18, 19, 19A) for enabling the user to select the appearance of the map; and
control means (20) for controlling the display unit (14) to modify the appearance of the map as a function of an appearance selection made by the user by means of the selection interface (16, 18, 19, 19A);
the workstation being characterized in that said interface includes means (19) for selecting the size only of at least one symbol; and
the control means (20) are adapted to cause the display unit (14) to modify the size of the or each symbol as a function of the selected size without modifying the scale of the map background.

2. A workstation according to claim 1, characterized in that the symbols are distributed by type, in that the interface (19) includes means for selecting size separately for each type of symbol, and in that the control means (20) are adapted to cause the display unit (14) to modify the size of all of the symbols of a given symbol type as a function of the size selected for that symbol type, without modifying the scale of the map background.

3. A workstation according to claim 1, characterized in that the or each symbol is associated with a set of pixel matrices having the same appearance, and having different dimensions, and in that the control means (20) are adapted to control the display unit (14) to display one of the pixel matrices as a function of the selected size.

4. A workstation according to claim 1, characterized in that said interface includes means (19A) for selecting a region of the map and means for modifying the scale of the background of the selected region of the map, without modifying the size of the symbols distributed over said selected region.

5. A workstation according to claim 1, characterized in that the selection means (19) are suitable for enabling the size of the or each symbol to be selected in predetermined steps.
